(19) United States
(12) Patent Application Publication
(10) Pub. No.: US 2010/0044447 A1
(43) Pub. Date: Feb. 25, 2010

(54) Temperature control for positive pressure air purification unit

(76) Inventor: Gregory R. Miller, Washington, MO (US)

Correspondence Address: KANG INTELLECTUAL PROPERTY LAW, LLC, 214 ELM STREET, SUITE 106, WASHINGTON, MO, 63090, US

(21) Appl. No.: 12/229,169

(22) Filed: Aug. 20, 2008

(51) Int. Cl. F24F 7/04; G05D 23/00

(52) U.S. Cl. 236/49.3; 700/299

(57) ABSTRACT

A temperature controller for a positive pressure room air purification unit is provided with a sensor for ambient room air temperature and supply duct air temperature. Based on the desired temperature, supply duct air may be drawn or drawn and heated.

### CROSS-REFERENCE TO RELATED APPLICATIONS

Not Applicable.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention is a temperature control for a positive pressure air purification unit and, more specifically, a temperature control using two temperature sensors for a positive pressure air purification unit.

2. Relate Art

The prior art for room air purification in a residential home uses a single air temperature controller and a single temperature sensor.

### SUMMARY OF THE INVENTION

The invention is a temperature controller that uses two sensors for controlling temperature in a room. The temperature controller is disposed in a positive pressure room air purification unit that is connected to a supply duct of a duct system of a standard residential HVAC duct system. The first temperature sensor senses ambient room air temperature. The second temperature sensor senses the air temperature of the air from a supply duct of a standard residential HVAC duct system. Based on the desired room air temperature, and the supply duct air temperature, the temperature controller determines whether to draw supply duct air, room air, or both, and further determines the fan speed setting of the purification unit, and whether to heat the air.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow chart that illustrates the operation of the temperature controller of the present invention.

### DETAILED DESCRIPTION OF THE PREFERRED EMBODIMENTS

The following description of the preferred embodiment(s) is merely exemplary in nature and is in no way intended to limit the invention, its application, or uses.

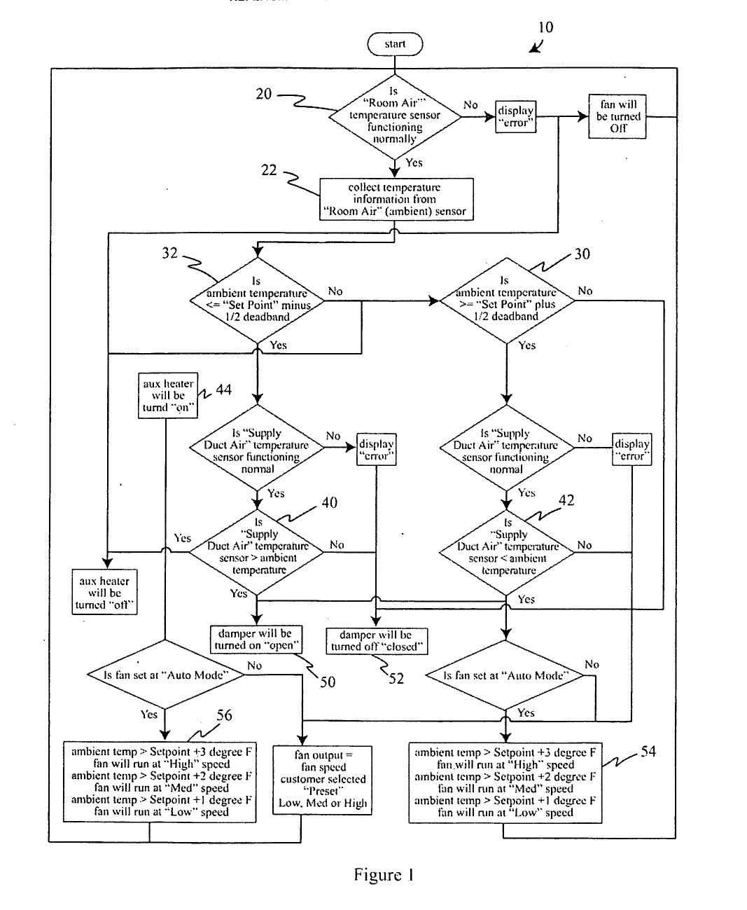

In FIG. 1, the operation of the temperature controller 10 of the present invention is provided. The normal operating environment for the temperature controller is a positive pressure room air purification unit. The room air purification unit is connected to a supply duct of a standard residential HVAC system. Initially, the temperature controller 10 determines whether the room air temperature sensor is functioning normally 20 and collects room air temperature information 20 via a temperature sensor located within the room air purification vent sensing ambient room air temperature.

Then, the temperature controller 10 determines whether the room air temperature is higher 30 or lower 32 than a calculated temperature which is based on a desired temperature and a deadband range. In addition, the temperature controller 10 determines whether the supply duct air temperature is higher 40 or lower 42 than the room air temperature. The temperature controller 10 is provided with a user interface for setting a desire room air temperature.

Based upon the desired temperature, a temperature range, and the room air temperature and the supply duct temperature, the temperature controller determines as shown in FIG. 1 whether the room air damper disposed with, which is infinitely movable between an open and a closed position, will be open 50 or closed 52, and whether to adjust the fan speed 54. The fan draws air from the through the supply duct and possibly through the room air damper through the positive pressure room air purification unit. After making the determination, the temperature controller operates to move the room air damper 50, 52 and operates to adjust the fan speed 54 so that the desired room air temperature may be achieved.

If the desired temperature is higher than the ambient room air temperature and supply duct air temperature, the auxiliary heater will be turned on 44 by temperature controller 10, and the fan speed will be adjusted automatically 56 if the unit is in “automatic mode.”

If the desired temperature is lower than the ambient room air temperature, and the supply duct air temperature is lower than ambient room air temperature, the temperature controller 10 will open 50 room air damper and the fan speed will be set automatically 54 if the unit is in “automatic mode.”

In order to maintain positive pressure, it will be appreciated that supply duct air at all times will be drawn by the positive pressure room air purification unit into the room. Ideally, the positive pressure room air purification unit will be equipped with a filtration system that will allow only purified air to pass through and exhaust into the room.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A temperature controller system for a positive pressure air purification unit comprising:
a first temperature sensor adapted to sense ambient room air temperature;
a second temperature sensor adapted to sense supply duct air temperature of an HVAC duct system;
a room air damper infinitely movable between an open and a closed position to allow air from the supply duct to be drawn or prevented from being drawn and positionally controlled by said temperature controller;
a user input interface for inputting a desired temperature;
a fan with a plurality of speed settings for drawing air from at least one of said supply duct and said room air damper and through said positive pressure air purification unit; and
wherein said room air damper is moved by said temperature controller between said open position and said closed position to achieve a desired temperature.

2. A temperature controller according to claim 1, wherein when said room air damper is in a closed position, no air may be drawn from the supply duct.

3. A temperature controller according to claim 2, wherein said room air damper will be moved to an open position when said supply duct air temperature is less than ambient room air temperature and said input desired temperature is less than ambient room air temperature.
